(19) United States
(12) Patent Application Publication
(10) Pub. No.: US 2008/0246603 A1
(43) Pub. Date: Oct. 9, 2008

(54) DIRECTION SEARCHING SYSTEM

(75) Inventor: Kenji MUTOU, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/048,437

(22) Filed: Mar. 14, 2008

(30) Foreign Application Priority Data
Apr. 9, 2007 (JP) 2007-101456

(51) Int. Cl. G08B 1/08

(52) U.S. Cl. 340/539.13

(57) ABSTRACT

The object of the invention is providing a direction searching system for displaying a direction of an objective car location only by easy operations. The solution is as follows. During a switch is being pressed in the first scan, a radio signal from a in-vehicle equipment 1 loaded in an objective car is received by rotating a terminal equipment 2 having a metal portion of Smart Key, etc. used as a directional antenna 10, and the maximum receiving level thereof is held by a peak-value detecting-and-holding unit 27. During a second scan, the switch 31 is released, and the radio signal from the in-vehicle equipment 1 loaded in the objective car is received by rotating the terminal equipment 2 again. During the above operation, the receiving level being detected by a level detector 25 is given to a comparing unit 28 to be compared with the maximum receiving level held as the first scan result. Subsequently, when the above receiving level thereof becomes approximately equal to the above maximum receiving level, the completion of the search is displayed by a displaying unit 40.

### BACKGROUND OF THE INVENTION

The present invention relates to a direction searching system for searching directions of mobiles using radio network technology such as ZigBee (registered trademark), especially, for searching cars parked in a parking lot.

This is a counterpart of Japanese patent application Serial Number 101456/2007, filed on Apr. 9, 2007, the subject matter of which is incorporated herein by reference.

Major retailers in the U.S. usually build large-scale parking lots. Meanwhile, it has becomes popular lately in Japan that large parking lots are built adjacently to shopping molls and large-scale retailers, however, it often happens that customers are caught up in shopping too much to remember parking locations of their cars. And it also happens that it becomes too dark to find parking locations of visitor's car when visitors return to the parking lots after theatergoing such as operagoing, etc.

There is a conventional electrical locking system called Smart Key for locking or unlocking doors by infrared lays or radio waves. The above system is configured that when locking or unlocking doors is commanded by pressing button of the Smart Key, cars corresponding to the identification number responds by flashing the hazard lamp or sounding the car horn, and lock or unlock the doors, and so on. There is no problem in the case where the searcher's cars are within the searcher's eyesight, however, the searcher's cars cannot be found in the case where the cars are located far from the searcher or out of the searcher's eyesight, and then there is a risk of stealing the load because the cars cannot be found even when doors are unlocked.

In Patent Document 1, Japanese Patent Application Laid-Open Publication Number 2006-104859, there is a description of a door locking control system for calculating accurately a distance between a car and a Smart Key using TM-CW (time-division modulated continuous wave). In the above door locking control system, there is an advantage that a distance between a car and a Smart Key can be measured even when the car is beyond visual range. However, a person carrying the Smart Key and searching the car cannot find the parking location, although the distance between the car and the Smart Key can be found.

In Patent Document 2, Japanese Patent Application Laid-Open Publication Number H10-198879, there is a description of a apparatus for searching a aged person having poriomania by emitting a radio wave from a emitter carried by the aged person being searched to measure the location of the aged person and displaying the measured location. The above searching apparatus consists of an antenna for searching direction by receiving the radio wave from the emitter, a receiving processor for measuring the direction and the intensity of the received radio wave, and a displayer for carrying out displaying the measuring result, and the above emitter carried by the aged person can be corresponded to a Smart Key. However, the above searching apparatus cannot be a Smart Key system corresponding to a specific car, and cannot authenticate exclusively on network. In addition, the configuration of the antenna for searching direction, etc. is immovable and has a large scale, and then it is impossible that the above system is adapted to mobile cars.

Every system described in the above Patent Documents 1, 2 finds the location of mobiles such as Smart Keys or the radio wave emitters, etc. on the side of immovable equipment in parked cars or searching apparatuses, etc., and then there is a problem that a parking location of a specific car, etc. cannot be found on the side of the mobiles.

### SUMMARY OF THE INVENTION

The object of the present invention is providing a direction searching system for searching a car parked in a large-scale parking lot, etc. beyond visible range by using a convenient terminal-equipment such as a Smart Key and for informing the searching person of the searched direction by an easy operation.

The present invention is a direction searching system for displaying a direction of a radio wave equipment on a side of mobile terminal by radio communication between the radio wave equipment loaded in an object being searched and the mobile terminal, wherein the above radio wave equipment is characterized by consisting of a directional antenna, a switch for controlling the searching operation, a level detecting-and-holding circuit for detecting levels of received radio signal from the above radio wave equipment to hold and output the maximum level of the above detected received levels after the above switch is pressed, a comparator for comparing received levels from the above radio wave equipment and the above maximum received level during a given period after the switch is released, and a displayer for carrying out displaying in accordance with the comparing results of the above comparator.

According to the present invention, the terminal equipment for searching the direction of the object being searched includes the level detecting-and-holding circuit for detecting the receiving level of the radio wave from the radio wave equipment loaded in the object being searched during the switch is being pressed and for holding and outputting the detected maximum receiving level after the switch is released. Consequently, a searcher can find the maximum receiving level from the radio wave equipment at the current location of the searcher by pressing the switch and simultaneously rotating the terminal. Furthermore, the above terminal includes the comparator for comparing received levels from the above radio wave equipment and the above maximum receiving level during a given period after the switch is released, and the displayer for carrying out displaying in accordance with the above comparing results. Consequently, the searcher can find the coming direction of the signal having the maximum receiving level by monitoring the display on the displayer during holding and rotating the terminal after releasing the switch of the terminal. Therefore, there is an effect that the searcher can find the direction of the location of the object being searched by an easy operation.

### BRIEF DESCRIPTION OF THE DRAWING

FIG. 1 is a configuration diagram of a direction searching system according to an embodiment of the present invention.

FIG. 2 is a configuration diagram of an example of the terminal equipment 2 in FIG. 1.

FIG. 3 is a conceptive diagram of an antenna directivity of the terminal equipment in FIG. 2.

FIG. 4 is an explanatory diagram of operations for searching directions by the searching direction system in FIG. 1.

### DETAILED DESCRIPTION OF THE PREFERRED EMBODIMENTS

The above mentioned and other objectives of the present invention, and the novelty of the present invention will become clear more thoroughly by reading the following description of the preferred embodiment referring to the drawings. However, the drawings are only for the explanation, and do not limit the scope of the present invention.

### First Embodiment

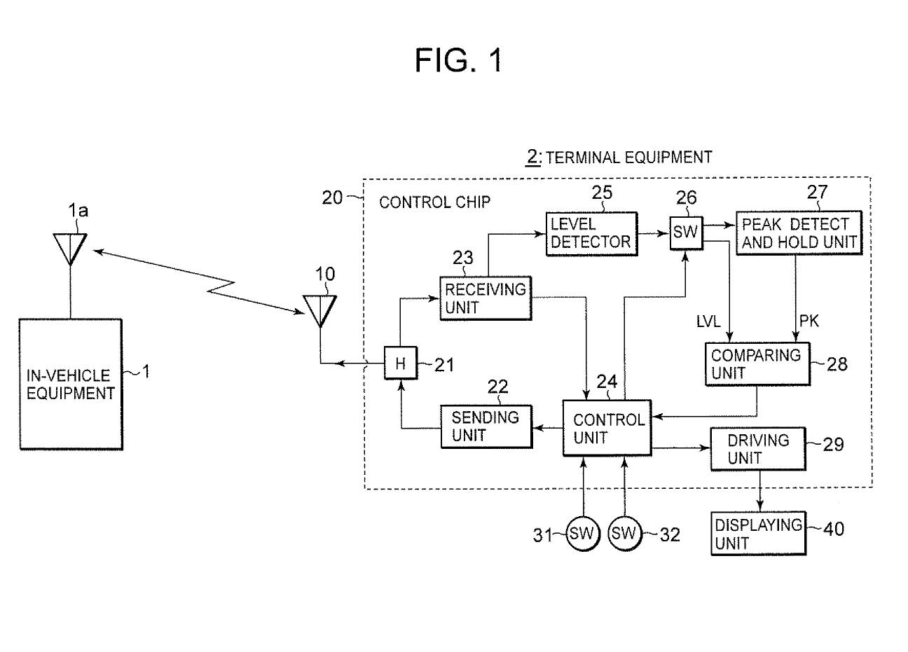

FIG. 1 is a configuration diagram of a direction searching system according to an embodiment of the present invention. The above direction searching system is for searching a direction of a car of an object being searched parked in a large-scale parking lot, etc, and consists of an in-vehicle equipment 1 having a non-directional antenna 1a, a terminal equipment 2 having a directional antenna. The in-vehicle equipment 1 and the terminal equipment 2 are connected each other by ZigBee radio network using 2.4 G band radio wave so that the in-vehicle equipment 1 operates as the ZigBee coordinator and the terminal equipment 2 operates as the ZigBee terminal.

The terminal equipment 2 includes a directional antenna 10, a control chip 20, an operating switch (SW) 31, 32, and a display unit 40 for displaying the searching results thereof.

The control chip 20 includes an antenna switching unit 21 for switching a sending signal to the antenna 10 and a receiving signal received by the above antenna 10, and a sending unit 22 and a receiving unit 23 are connected to the above control chip 20. The sending unit 22 is for sending a radio signal to the in-vehicle equipment 1 according to control by a control unit 24, and the receiving unit 23 is for receiving a radio signal sent by the in-vehicle equipment 1. The receiving signal received in the receiving unit 23 is sent to the control unit 24, and the intensity level of the above receiving signal is given to the level detector 25.

The level detector 25 is for detecting the signal level received by the receiving unit 23, and the detecting results thereof are sent to a peak detect and hold unit 27 or a comparing unit 28 through a switch 26 according to control by the control unit 24. The peak detect and hold unit 27 is for detecting a peak of the signal given through the switch 26 and holding the detected peak-value thereof. The comparing unit 28 is for comparing the signal level given through the switch 26 and the peak-value held by the peak detect and hold unit 27 so as to give the comparing results thereof to the control unit 24.

In addition, the control unit 24 consists of a microprocessor operating by a control program, and conducts communication with the in-vehicle equipment 1, based on the signal from the switches 31, 32, according to the predetermined protocol stipulated by ZigBee radio network, and simultaneously, conducts the whole control inside the control chip 20. A driving unit 29 for driving the display to a display unit 40 based on the comparing results from the comparing unit 28 is connected to the above control unit 24.

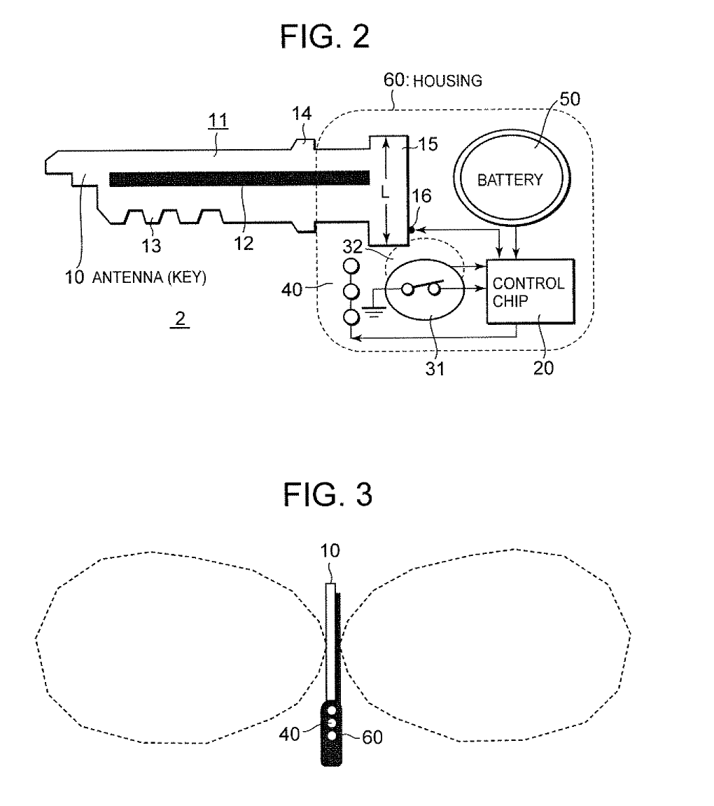

FIG. 2 is a configuration diagram showing an example of the terminal equipment 2 of FIG. 1. The terminal equipment 2 is combined with a Smart Key, and is configured to use a metal portion of the key 11 as the directional antenna 10. Furthermore, The control chip 20 of circuits in a single chip, the switches 31, 32 for operation, and a display unit 40 are mounted in a housing 60 of dielectric such as plastics, etc. with a power-supply battery 50, and the housing 60 is attached to a handle of the Smart Key.

As shown in FIG. 2, the metal portion of the key 11, the dielectric housing 60 covering the above metal portion of the key 11 and the internal circuits, etc., small-size LEDs (light emission diode) of the display unit 40, and push button of the switches 31, 32 for operation can be seen outside the Smart Key. Furthermore, necessary wrings or interconnections are carried out, in the control chip 20 and the battery 50, etc.

The metal portion of the key 11 consists of a groove of the key 12, a bitting of the key 13, a stopper 14, and an internal metal supporting unit 15, etc. corresponding to a key mechanical structure, however, the above internal metal supporting unit 15 is designed to work as a part of antenna. In otherwords, the internal metal supporting unit 15 ties physically and strongly the housing 60 and the metal portion of the key 11 together, and works as the resonance unit of the antenna 10.

The length of the resonance unit (resonance length) L=λg/4, in the case where high frequency wavelength is λg within the dielectric comprising the housing 60. The wavelength λg has a relationship of λg=λ 0/√(ε r) to the wavelength in vacuo of λ 0, wherein ε r is a specific inductive capacity of the dielectric surrounding the resonance unit. For example, in the case of sealant plastic, ε r becomes 4 to 5 at 2.4 GHz. Consequently, the resonance length is around 15 mm. However, since the shape of the metal portion of the key 11 is complicated and includes a plural of reflection edges according to the reciprocating path of the electric signals, it is difficult to realize an ideal resonance characteristic. Therefore, the shape and dimensions of the resonance unit needs to be determined based on the test results of prototypes. Furthermore, a feeding point 16 being connected to the antenna-switching unit 21 of the control chip 20 needs to be placed at a point having small a reflection mode, similarly using prototypes.

The switch 31 is for searching a car location. Pressing the above switch 31 makes the control unit 24 of the control chip 20 carry out a first and a second scans mentioned as below. The switch 32 is for locking and unlocking doors of cars. Pressing the above switch 31 makes the control unit 24 of the control chip 20 carry out a main function of the Smart Key of locking and unlocking doors of cars.

The display unit 40 includes three small LEDs aligned in parallel, and the control chip 20 is configured to light on and off the LEDs after the second scan for searching a car location.

FIG. 3 is a conceptual diagram of directivity of the antenna of the terminal equipment of FIG. 2. Since the metal portion of the key 11 of the antenna 10 is a plate, sensitivity becomes the max to the electric field parallel to the resonance unit 15. Consequently, in the case of picking up the Smart Key by fingers during the operation, since the key is set up vertically, the sensitivity to transverse magnetic becomes the max. And since the shape of the metal portion of the key 11 is complicated, the ideal directivity such as in FIG. 3 cannot be necessarily achieved, however, it is preferable to place the antenna 1a connected to the in-vehicle terminal 1 so as to have the maximum sensitivity to a transverse magnetic.

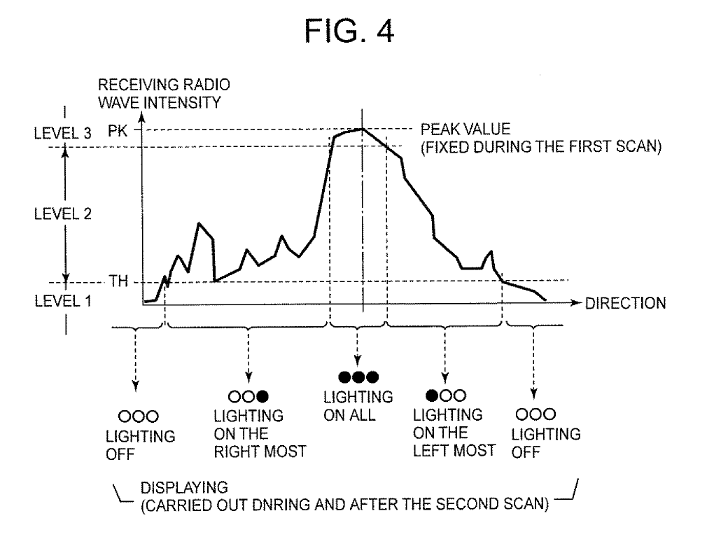

FIG. 4 is explanatory diagram of operations for searching directions by the direction searching system in FIG. 1. The method for searching directions will be explained as below, referring to the above FIG. 4.

(1) First Scan

A searcher searching the searcher's car sets up the key portion of the terminal equipment (Smart Key) 2 vertically, and rotates the above key portion by at least more than 180 degrees, pressing the switch 31.

By pressing the switch 31 (to on-state), the control unit 24 switches the switch 26 to the side of the peak detect and hold unit 27 and carry out simultaneously communication with the in-vehicle terminal 1 according to the predetermined protocol. The radio signal sent from the in-vehicle terminal 1 is received by the antenna 10 of the Smart Key 2 and given to the level detector 25 through the receiving unit 23 to detect the receiving level thereof. The above receiving level detected by the level detector 25 is given to the peak detect and hold unit 27 through the switch 26.

At the above time point, since the Smart Key 2 receives the radio signal from the in-vehicle terminal 1 during being rotated, the receiving level changes according to the direction due to the directivity of the antenna 10.

FIG. 4 is a view of relationship between the intensity of the receiving electric field received in the direction of the Smart Key 2 at the first scan and the direction of the Smart Key 2. For example, assuming that the sending antenna power is 1 dBm (0 dBm=1 mW) in the case of measuring in the outside at the distance of 100 m, the peak value of −40 to −80 dBm can be expected. It is well known that a code error rate is low and a reliable communication even at the above receiving level of around −80 dBm.

During the switch 31 is being pressed, the communication with the in-vehicle terminal 1 is continued, and the peak detect and hold unit 27 updates the peak value corresponding to the receiving level given sequentially. In other words, in the case where the given receiving level becomes higher than the held receiving level, the receiving level is held again, and in the case where the given receiving level is lower than the held receiving level, the given receiving level is neglected.

When the switch is released to off state, the first scan is finished. In the above process, the maximum receiving level PK at the current site is held in the peak detect and hold unit 27. In the first scan, the reason why the Smart Key 2 needs to be rotated by at least more than 180 degrees is that the maximum receiving level PK can be measured by rotating the Smart Key 2 by 180 degrees because the antenna directivity of the above Smart Key 2 has a symmetrical characteristic having two peaks in two directions as shown in FIG. 3. In addition, it goes without saying that rotating the Smart Key 2 by more than 360 degrees is necessary in the case of the antenna having a directivity having a peak in one direction.

The maximum receiving level PK obtained in the first scan is used as a criterion for determining the direction of the searched car in the second scan.

(2) Second Scan

A second scan is carried out for a certain period (for example, ten seconds) after the switch 31 is released.

The control unit 24 switches the switch 26 to the side of the comparing unit 28 and monitors the comparing results of the above comparing unit 28 after detecting the switch 31 to be released (to off state). In addition, during the above second scan is being carried out, the communication with the in-vehicle terminal 1 is continued according the predetermined protocol.

Meanwhile, the searcher rotates the Smart Key 2 by at least more than 180 degrees, setting the key up vertically and monitoring the LEDs of the display unit 40. By the above operations, the radio signal sent from the in-vehicle terminal 1 is received by the antenna 10 of the Smart Key 2 and given to the level detector 25 through the receiving unit 23 to detect the receiving level thereof. The receiving level detected by the level detector 25 is given to the comparing unit 28 through the switch 26.

At the above time point, since the Smart Key 2 receives the radio signal from the in-vehicle terminal 1 during being rotated, the receiving level LVL is changed by the receiving direction due to the directivity of the antenna 10.

The comparing unit 28 outputs three levels based on a receiving level LVL detected by the level detector 25 and the maximum receiving level PK obtained during the first scan and held by the peak detect and hold unit 27. For example, a level 1 is outputted in the case where the receiving level LVL is less than a threshold level TH (for example, −90 dBm), a level 2 is outputted in the case where the receiving level LVL is not less than the threshold level TH and is less than the maximum receiving level PK by a small margin (for example, 1 dB), and a level 3 is outputted in the case where the receiving level LVL is not less than the threshold level TH and is not less than the maximum receiving level PK by the small margin.

The control unit 24 displays according to the comparing results by the comparing unit 28 using the display unit 40 through the driving unit 29. For example, as shown in the lower part of the graph in FIG. 4, in the case where the output of the comparing result by the comparing unit 28 is level 1, the control unit 28 lights off all three LEDs of the display unit 40. In the case where the comparing result is level 2, the control unit 28 lights on only the rightmost LED. In the case where the comparing result is level 3, the control unit 28 lights on all three LEDs. In addition, in the case where the level 3 is changed to the level 2, the control unit 28 lights on only the leftmost LED.

The searcher can estimates the direction of the searcher's car location by the direction of the Smart Key 2 in the case where all the LEDs are turned on. In the above case, since the antenna directivity of the Smart Key 2 is symmetrical as shown in FIG. 2, the direction of the car location is in the right or left direction.

As explained before, since the direction searching system according to the present embodiment includes the Smart Key 2 for carrying out the communication with the in-vehicle terminal 1 to hold the maximum receiving level PK among the signals received from the in-vehicle terminal 1 during the first scan operation and display that the signal received from the in-vehicle terminal 1 becomes around the maximum receiving level PK during the second scan operation, there is an advantage that the direction of the objective car location can be displayed by an easy operation.

In addition, the present invention is not limited to the aforementioned embodiment, and various modifications are possible. Examples of the modifications are as follows.

(a) The reason why ZigBee is used as an example of the radio network between the in-vehicle terminal 1 and the Smart Key 2 is that ZigBee is suitable to be applied to the Smart Key because ZigBee can configure the radio network for long-time operation using only battery. Consequently, in the case where the battery has enough capacity, short haul radio networks such as Bluetooth, UltraWideband (both are registered trademarks) can be used.

(b) In consideration of using the system at night and downsizing the display, the display unit of LEDs is used, however, a liquid-crystal display with back-light or display method using sounds or voices can be used.

(c) A Smart Key is used as the terminal equipment and the metal portion of the key 11 is used as the directive antenna 10, however, a dedicated terminal equipment using a high-performance antenna having a single directivity can be used.

(d) A method for displaying the receiving level using LEDs during the second scan operation is not limited to the aforementioned method, and a method for lighting on LEDs of zero, one, two, or three pieces corresponding to the receiving level can be used, for example.

What is claimed is:

1. A direction searching system for displaying a direction of a radio-wave-equipment location on a mobile terminal-equipment by carrying out radio-wave communication between the radio-wave equipment loaded in an object being searched and the mobile terminal-equipment:
the mobile terminal-equipment comprising:
a directional antenna;
a switch for controlling searching operation;
a level detecting-and-holding circuit for detecting a receiving level of the radio wave from the terminal equipment during the switch is being pressed, and holding the maximum receiving level among the detected receiving levels to output the maximum receiving level held thereby after the switch is released;
a comparator for comparing a receiving level of receiving radio signal from the radio-wave equipment and the maximum receiving level during a given period after the switch is released; and
a displayer for carrying out displaying in accordance with the comparing results of the comparator.

2. The direction searching system of claim 1, wherein the displayer displays that the direction searching is completed in the case where differential between the receiving level of the radio signal received from the radio wave equipment and the maximum receiving level is within a given value, or the receiving level is higher than the maximum receiving level.

3 The direction searching system of any of claim 1 or claim 2, wherein the object being searched is a parked car and the terminal equipment is configured to be combine with a key of the car.

4. The direction searching system of claim 3, wherein the metal portion of the key of the car is used as the antenna.

5. The direction searching system of claim 4, wherein the radio-wave communication between the radio-wave terminal and the terminal equipment is carried out by ZigBee radio-wave network system using the radio-wave terminal as the coordinator.
